(19) United States
(12) Patent Application Publication
(10) Pub. No.: US 2026/0300497 A1
(43) Pub. Date: Oct. 1, 2026

(54) USER INTERFACE FOR AUTOMATED REMEDIATION FOR SECURITY PLATFORMS

(71) Applicant: Palo Alto Networks, Inc., Santa Clara, CA (US)

(72) Inventors: Wen Jiang, Sunnyvale, CA (US); Dwarika Lal, Danville, CA (US); Ning Song, Milpitas, CA (US); Aurelie Michel Saliba, San Jose, CA (US); Corbin Burke Hadley, Seattle, WA (US)

(21) Appl. No.: 19/094,638

(22) Filed: Mar. 28, 2025

(51) Int. Cl. G06F 21/57; G06F 21/55

(52) U.S. Cl. CPC G06F 21/577; G06F 21/554

(57) ABSTRACT

Techniques for a User Interface (UI) for automated remediation for security platforms using signature generation are disclosed. In some embodiments, a method for automated remediation for security platforms using signature generation includes selecting one or more sources associated with a security platform, selecting one or more functions to perform one or more checks on the one or more sources, combining the one or more checks and the one or more functions, and automatically generating a remediation signature.

### BACKGROUND OF THE INVENTION

Security vendors provide security platforms to customers. These security platforms may fail or suffer performance problems in a variety of ways. Examples of security platforms include firewalls, gateways, network nodes, etc. Subject Matter Experts (SMEs) attempt to diagnose the failure of the security platforms through signature generation. The SMEs interface with product managers (PMs) in order to further discuss diagnoses and solutions to security platform failures and/or performance issues. PMs typically create requirements for engineers to develop a solution to the security platform failures and/or performance issues. The engineers may work with the SMEs and PMs to develop solutions to the security platform failures and/or performance issues. This process may take several months (e.g., is human labor intensive and costly) and can be prone to errors. As such, this inefficient approach generally slows down the process of fixing security platform failures and/or performance issues, and it also hampers the ability of the security vendor to provide a desirable security platform service/solution for its customers.

### BRIEF DESCRIPTION OF THE DRAWINGS

Various embodiments of the invention are disclosed in the following detailed description and the accompanying drawings.

FIG. 1 is a block diagram of a system for using security platform SME knowledge to remediate security platforms in accordance with some embodiments.

FIG. 2 is a block diagram of a system to facilitate remediation signature generation in accordance with some embodiments.

FIG. 3 is a block diagram of a system to develop and deploy security platform remediations in accordance with some embodiments.

FIG. 4 is a flow diagram for generating a remediation signature in accordance with some embodiments.

FIG. 5 is a flow diagram of a process for generating a signature using an LLM in accordance with some embodiments.

FIG. 6 is a flow diagram for deploying and managing a security platform remediation in accordance with some embodiments.

FIG. 7 is a flow diagram of a process that a user may use to generate a signature in accordance with some embodiments.

FIG. 8 is an example of a user interface (UI) available to a user for generating a remediation signature in accordance with some embodiments.

FIGS. 9-13 are examples of a UI for generating a remediation signature in accordance with some embodiments.

FIG. 14 is an example of instructions which comprise a prompt in accordance with some embodiments.

FIG. 15 is an illustration of part of an example ticket-signature pair which comprises a prompt in accordance with some embodiments.

FIG. 16 is an illustration of another part of an example ticket-signature pair which comprises a prompt in accordance with some embodiments.

FIG. 17 is an example of further instructions which comprise a prompt in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Security platforms, such as firewalls, gateways, network nodes, etc., may be subject to many failures while being used in production. Examples of failures include configuration errors, overloaded systems, failures due to malicious actors, hardware bottlenecks, missing firewall policies, etc. Often, the providers of security platforms and customers rely on a team of employees with different job titles to collaborate. Ideally, the result of the collaboration is the rapid identification of the security platform's failure and rapid remediation of the failure.

For example, a subject matter expert (SME) is tasked with identifying the failure and providing remediation steps for the customers using the firewall. Current solutions require the SME to connect to the firewall, check the firewall's source files (e.g., command outputs, logs, configuration source files, etc.), identify the issue through certain metrics in source files, provide remediation steps for customers, and check certain metrics from source files to make sure the issue/failure is resolved.

This is a time-consuming process for the SME and the knowledge gained by the SME through executing this process (e.g., possible general remediation steps, methods of identifying issues, etc.) is lost. Lost knowledge may also occur because SMEs each have a non-standardized way of documenting this process (e.g., generating signatures).

Other current solutions attempt to use communication between product managers (PMs) in order to facilitate quicker solutions with the SMEs. PMs may talk with SMEs to gather firewall problems and attempt to understand how these issues are detected and resolved manually. The PM may create requirements for engineers to convert the SMEs'domain knowledge into code logic in order to achieve remediation of the issue. Then PMs, SMEs and engineers work together in order to see that the remediation of the original issue is achieved, for example, by tweaking code logic.

The described processes lead to many issues and slow down remediation of issues with security platforms. The uneven distribution of information between SMEs, PMs, and engineers along with the communication costs associated with communications between all three parties lead to inefficiencies. Furthermore, the nonstandard generation of signatures by SMEs may lead to inefficiencies and error prone solutions.

The techniques disclosed herein solve these problems by introducing a standardized method of remediation signature (i.e., signature) generation and remediation lifecycle management. A user (e.g., an SME) selects one or more sources associated with a security platform. The user selects a function to perform checks on the one or more sources. The checks from all sources are combined. A remediation signature is automatically generated from the checks on all sources.

In some embodiments, the techniques disclosed herein use a Large Language Model (LLM) to produce a remediation signature. A support ticket is received from the user. The support ticket is normalized. A prompt associated with the normalized ticket data is produced. The prompt and the normalized ticket data are used on an LLM to produce a signature draft for display on a UI. The user is provided with the UI and allowed to finalize the remediation signature. In some embodiments, the finalized remediation signature and the normalized ticket data pair are used to improve the prompt producer.

The techniques disclosed herein allow for rapid communication of issues between all parties involved in remediation of security platforms. The techniques disclosed herein provide that remediation signatures are generated and stored in a standardized format. This provides advantages in integrating expertise from all SMEs and more rapidly generating remediation signatures. Furthermore, processes of applying remediation in production are greatly sped up with the techniques disclosed herein. Engineers generating remediations are allowed to focus on evaluation of domain specific conditions without requiring a deep understanding of the domain knowledge. LLM aided signature draft generation greatly reduces required signature creation time and cost. Signature generation may be done in a manner that requires low amounts of coding or no amount of coding. This significantly reduces the time and effort required to detect, diagnose, and remediate all issues in network security deployment.

The techniques disclosed herein may be effectively utilized with minimal training for those who are proficient in manual security platform troubleshooting.

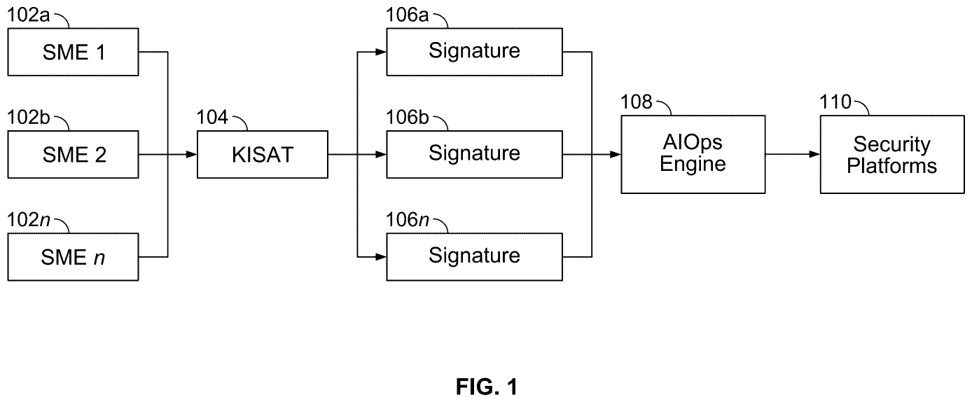

FIG. 1 is a block diagram of a system for using security platform SME knowledge to remediate security platforms in accordance with some embodiments. SMEs 102a, 102b, . . . , 102n use Known Issues Signature Authoring Tool (KISAT) to generate remediation signatures 106a, 106b, and 106n. Artificial Intelligence Operations (AIOps) Engine 108 uses remediation signatures 106a, 106b, and 106n to remediate/repair security platforms 110.

In some embodiments, Artificial Intelligence Operations (AIOps) Engine 108 uses remediation signatures 106a, 106b, and 106n to suggest remediations/repairs to security platforms 110.

SME 102n may be any subject matter expert that diagnosis issues with one or more security platforms 110. A security platform may be a network security platform such as firewalls, gateways, network nodes, etc. In some embodiments, SMEs 102a:n have expertise in the security platforms of a particular provider of network security platforms (e.g., Palo Alto Networks™). For example, SMEs 102a:n have particular expertise in a certain aspect of firewall repair. KISAT 104 provides the ability to store this expertise in a standardized manner for future use.

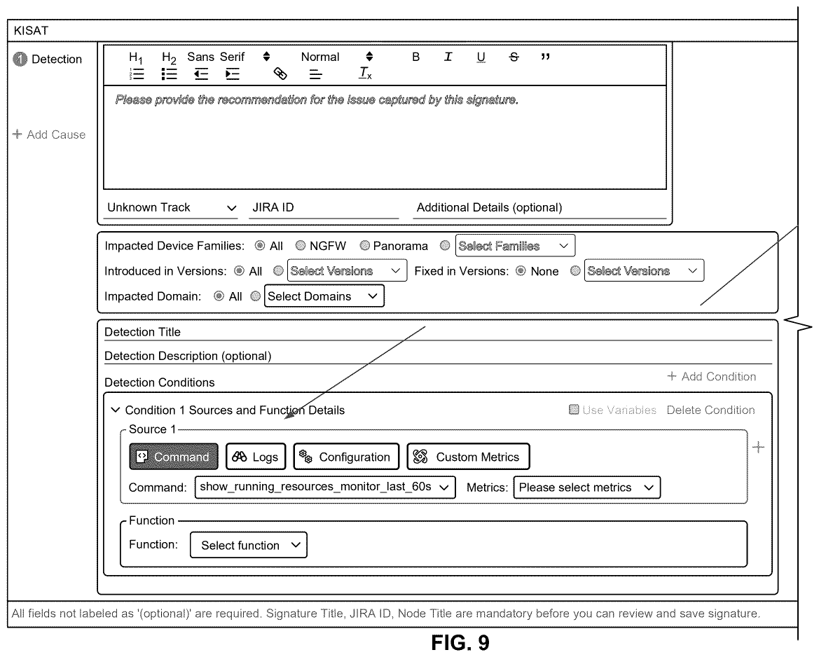

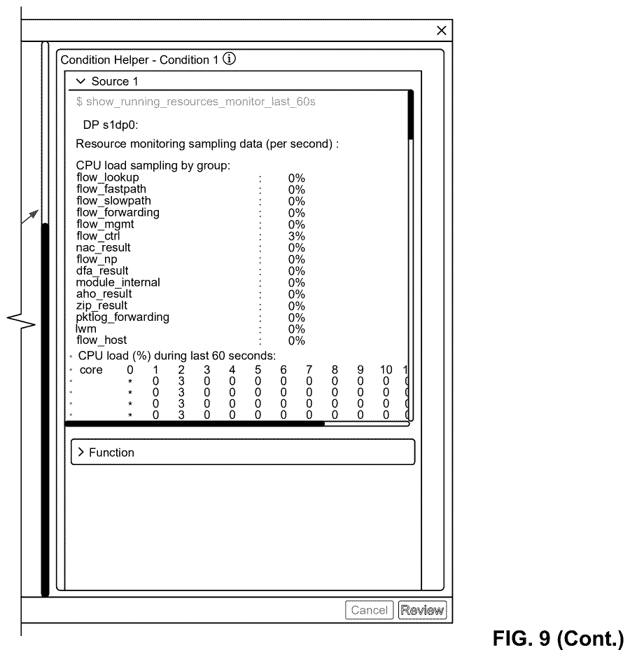

KISAT 104 is any user interface (UI) that may be used by SME 102a:n to generate a remediation signature. Screenshots of an example UI that may be used for KISAT 104 are provided in FIGS. 9-13. KISAT 104 may provide SMEs 102a:n with the ability to rapidly sift through security platform command outputs, logs, configuration source files, etc.

In some embodiments, generating remediation signature 106n includes identifying a series of different aspects relating to an issue with a security platform. Examples of different aspects relating to an issue include potential detection areas, causes, issues relating to a data lake, potential root causes, and potential remediations. In some embodiments, SME 102n generates the remediation signature by producing a chain of these different aspects in a logical order (e.g., beginning with detection areas and ending with potential remediations). The preparation of each link in this chain is guided through UI (e.g., a wizard).

In some embodiments, KISAT 104 provides SME 102n with a UI to select any source of a security platform issue (e.g., including, for example, firewall configuration, firewall daemon logs, firewall device key metrics such as, data plane central processing unit (CPU) usage, memory usage, disk usage, tunnel status, certification expiration info, etc.). Next, SME 102n may attempt to diagnosis the issue by identifying one or more potential causes. Next, SME 102n may be able to select potential root causes. When investigating/determining the diagnosis, detection areas, causes, etc., the UI provides an example of checks/commands (e.g., commands on a terminal) to run on the security platform that will allow for production of information relating to what SME 102n is attempting to accomplish in a particular step.

In some embodiments, examples of the results of each check/command are also provided. Examples of results comprise the exemplary results of running the check/command on a security platform. For example, if the check/command “show running resources monitor last 60 s” is selected, an output that a security platform would produce in response to the check/command is displayed. This allows SME 102n to quickly determine if the check/command being run will produce results relevant to the suspected issue.

In some embodiments, each aspect of KISAT 104 requires SME 102n to provide natural language descriptions of a thought process. For example, when investigating an issue, the author of the remediation signature may have to provide a write-up discussing the issue impact and the potential remediation steps.

In some embodiments, KISAT 104 provides SME 102n with functions. Detection functions are pre-configured methodologies to detect issues with a security platform. Examples include a rule-based detector, anomaly detector, correlation detector, abnormal memory usage detector, buffer description, etc. To further illustrate, a rule-based detector may provide SME 102n with commands to research whether particular rules relating to a security platform's operation are met (e.g., is CPU usage for a particular process in a particular range over time?). An anomaly detector may provide SME 102n with the commands to detect an anomaly in the security platform.

Functions may include detection conditions that allow SME 102n to detect whether certain conditions relating to the functions are met, exceeded, or lower. These conditions allow SME 102n to use their subject matter knowledge to diagnose issues. In some embodiments, functions comprise one or more checks.

In some embodiments, when SME 102n identifies a function, KISAT 104 generates the particular command necessary to run the function on a security platform.

In some embodiments, each function provides a dropdown menu of potential commands to run on a security platform that may help in detecting the issue or running the command.

KISAT 104 may provide one or more dropdown menus which include information potentially relevant to SME 102n's signature generation. For example, the impacted device families may have a dropdown which includes the data plane, packet buffers, packet descriptors, session tables, etc. In some embodiments, these options in the dropdown menu further include potential issues with the provided device family.

KISAT 104 may allow an SME 102n to select sources associated with a security platform e.g., data plane, packet buffers, packet descriptors, session tables, etc. With a source selected, KISAT 104 provides a UI to assist in investigating problems with the sources. This UI may comprise suggesting functions which perform checks on one or more sources. In some embodiments, the checks and the sources are combined. A remediation signature is automatically generated from SME 102n's input into KISAT 104. This remediation signature comprises the checks and sources input by SME 102n. However, the remediation signature may comprise other data produced by SME 102n in developing the remediation signature using KISAT 104.

Another example of the use of dropdown menus includes the various commands that may be run on a security platform to analyze logs, configuration files, command outputs, etc. for use in remediation. Examples of commands include the following (without limitation): anomaly detector, anomaly baseline detector, correlation detector, abnormal memory usage detector, crash detector, daemon log match, rule-based detector, etc. Other examples of data that SME 102n may provide KISAT 104 in signature generation include the overall impact of the issue described by the signature, what version the issue may have been introduced in, the impacted domains, the impacted device models, how this signature is correlated with other signatures, tracing logs to identify disruption sources, etc.

In some embodiments, checks may be provided to the user through one or more UI features such as dropdown menus.

When SME 102n completes the use of KISAT 104, a file in a known and standardized format is generated which includes all information generated by SME 102n relating to the signature (e.g., natural language write-ups, commands, conditions, functions, impacted device families, etc.).

Remediation signature 106n is comprised of all data produced by SME 102n through using KISAT 104 to approach an issue in a security platform. In some embodiments, a remediation signature is a file with a particular format. For example, remediation signature 106n may be in JavaScript Object Notation (JSON). Each key in the JSON may point to certain data that is produced by using KISAT 104. For example, there may be a key which comprises the commands used by SME 102n to check for certain issues with a security platform.

Other examples of formats of remediation signatures 106a:n include YAML, XML, HTML, . . . etc. Any format that may be used to represent inputs into a standardized UI may be used. Remediation signature 106n is used by AIOps engine 108 to remediate issues with security platforms 110.

Remediation signatures 106a:n may be available for all parties involved in detecting and remediating solutions with security platforms (e.g., SMEs, PMs, and engineers). This greatly reduces the cost of communication between all involved parties and allows for faster improvement of security platforms. Furthermore, the ease of understanding each remediation signature 106n by each party is greatly increased because of the standardized format of the remediation signatures.

AIOps engine 108 uses the standardized remediation signatures 106a:n to improve/remediate security platforms, such as firewalls. For example, suppose SME 102n uses KISAT 104 to produce a remediation signature 106n which shows that CPU usage is anomalous and that uniform resource locater (URL) cache lookup is a likely root cause of the problem. AIOps engine 108 may develop a patch for the problem in the URL cache look up of a security platform.

AIOps engine 108 may utilize Artificial Intelligence (AI) methods to patch issues in a security platform. These methods include code generation, long term reasoning, planning, one or more neural networks, natural language processing, trial and error, etc. Remediation signatures 106a:n are provided to AIOps engine 108 in a standardized form. Thus, AI can be applied to any remediation signature generated through the techniques disclosed herein. In another example, AI may be used to sort through a large number of remediation signatures 106a:n to introduce efficiencies to the process of dealing with a large number of such signatures. One example is presenting engineers with remediation signatures 106a and 106b when both likely have similar root causes.

AIOps engine 108 may comprise an LLM that may be used to summarize remediation signature 106n for all parties (e.g., SMEs, PMs, and engineers), such that the description matches the needs of each party.

In some embodiments, AIOps engine 108 comprises human resources (e.g., engineers) which respond to standardized remediation signatures 106a:n through developing the necessary remediations.

In some embodiments, AIOps engine 108 uses AI methods in conjunction with human intervention to act on remediation signatures 106a:n.

In some embodiments, solutions developed by AIOps engine 108 may later be implemented on security platforms 110. For example, if it is determined that the solution developed by AIOps engine 108 is applicable to a plurality of similar security platforms, a security platform provider may provide a similar service to one or more companies. A solution to one company's firewall may be useful for all companies that utilize the similar firewall.

Security platforms 110 is any group of network security platforms that are administrated by a group (e.g., a network security company). Examples of security platforms include the following (without limitation): firewalls, gateways, network nodes, etc. The group that administers the security platforms may be an entity (e.g., a company, government, organization, etc.). In some embodiments, a remediation signature 106n that is associated with a single security platform of a group of security platforms is useful for improving all similar security platforms administered by a group (e.g., the security platforms 110). Thus, when AIOps engine 108 develops a remediation, the knowledge garnered in that process may be used to improve the security platform as a whole for all users.

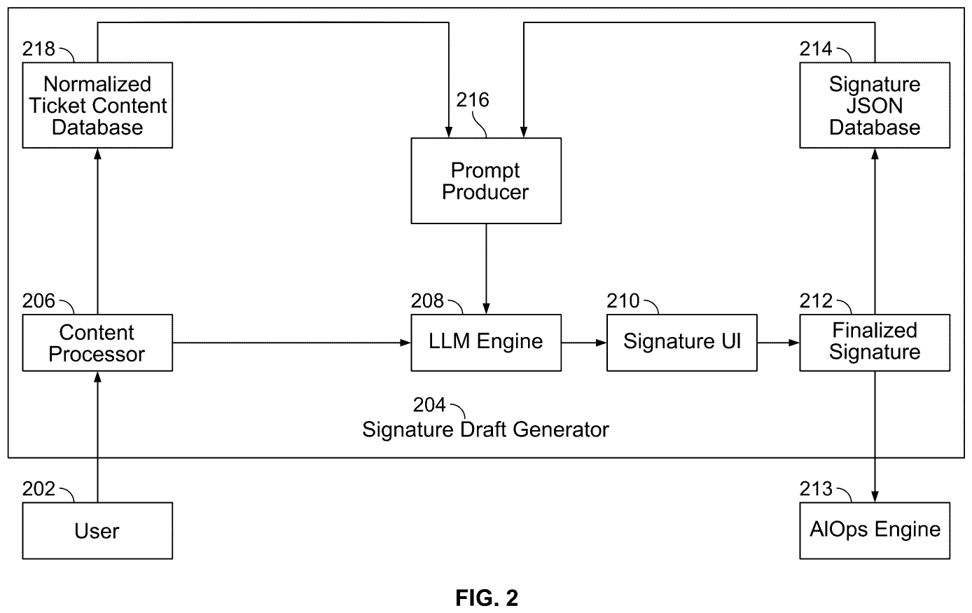

FIG. 2 is a block diagram of a system to facilitate remediation signature generation in accordance with some embodiments. User 202 creates a ticket comprising an issue with a security platform. The ticket is sent to content processor 206. The processed ticket is sent to both LLM engine 208 and normalized ticket content database 218. LLM engine 208 prepares the ticket for display in signature UI 210 (e.g., KISAT). User 202 is able to finalize the signature, producing finalized signature 212. Finalized signature 212 is sent to signature JSON database 214 and AIOps engine 213. AIOps engine 213 may be used to implement the remediation associated with finalized signature 212. Prompt producer 216 uses the pair of the finalized signature 212 from signature JSON database 214 and the normalized ticket content database 218 to improve the efficacy of LLM engine 208.

User 202 is any user attempting to remediate an issue with a security platform. In some embodiments, user 202 is an SME. User 202 may develop a ticket (e.g., a support ticket) with the goal of addressing an issue in a security platform. This may be done by any appropriate service (e.g., Jira™, Salesforce™, etc.). The support ticket may comprise a diagnosis, an effected area, a suggested solution, etc. The support ticket is sent to signature draft generator 204. In some embodiments, support tickets sent to signature draft generator 204 are first sent to content processor 206.

Signature draft generator 204 receives input from user 202 and develops a signature (e.g., a remediation signature) which allows for future action on the issue identified through the input (e.g., by AIOps engine 213). User 202 provides input through initially sending a ticket but also through interacting with signature UI 210. In some embodiments, signature draft generator 204 is a self-improving system. This is because the LLM engine 208 may be trained to develop better signatures, using pairs of initial inputs by user 202 and finalized signature 212.

Content processor 206 receives input from user 202 and normalizes the input. In some embodiments, input from user 202 comprises a support ticket for an issue in a security platform such as firewalls, gateways, network nodes, etc.

Normalizing input includes creating input that is standardized for further use by signature draft generator 204. Content processor 206 may normalize input by distilling the relevant user input for further processing by signature draft generator 204. For example, suppose a user 202 sends a ticket created in JIRA™. The ticket may contain outlining information or boilerplate information that is unnecessary for signature draft generator 204. Content processor 206 may normalize this data by removing this outlining/boilerplate information. The process of normalizing allows support tickets from a variety of sources to be represented to signature draft generator 204 in a standardized manner. This allows for the more efficient processing of support tickets.

Content processor 206 sends normalized input to normalized ticket content database 218 and to LLM engine 208.

Normalized ticket content database 218 is a database comprising a plurality of normalized data generated by users and processed by content processor 206. The normalized ticket content may be used by prompt producer 216 in a pair of normalized ticket content to finalized signature 212.

LLM engine 208 is any LLM that is used to transform normalized ticket content to a standardized format for display and manipulation on signature UI 210. LLM engine 208 may produce a file of any format that can be interpreted to create signature UI 210 (e.g., JSON, YAML, XML, HTML, etc.). LLM engine 208 may comprise any LLM (e.g., Gemini™, ChatGPT™, Claude AI™, etc.).

LLM engine 208 may comprise a specialized LLM that is trained and/or fine-tuned on a plurality of pairs of normalized ticket data and finalized signatures using supervised learning where the finalized signatures are the labels. LLM engine 208 may be trained in any other appropriate way.

In some embodiments, normalized ticket content produced by content processor 206 is used on LLM engine 208 in conjunction with a prompt produced by prompt producer 216. Prompt producer 216 produces a prompt which comprises the normalized ticket data produced by content processor 206 and a query for LLM engine 208 to produce a signature for use by signature UI 210. Prompt producer 216 may produce a prompt which comprises examples of normalized ticket data and finalized signatures.

In some embodiments, a retrieval-augmented generation (RAG) approach is utilized to generate signatures from normalized content produced by content processor 206. For example, normalized content ticket data may be provided from content processor 206 along with one or more example normalized ticket-signature pairs. These pairs may be provided by prompt producer 216. The prompt for LLM engine 208 may include instructions to use the pairs as examples to generate a signature corresponding to the normalized ticket data. As the normalized ticket/signature pairs improve and are more numerous, the initial signature produced by LLM engine 208 will improve such that user 202 achieves a more desirable signature.

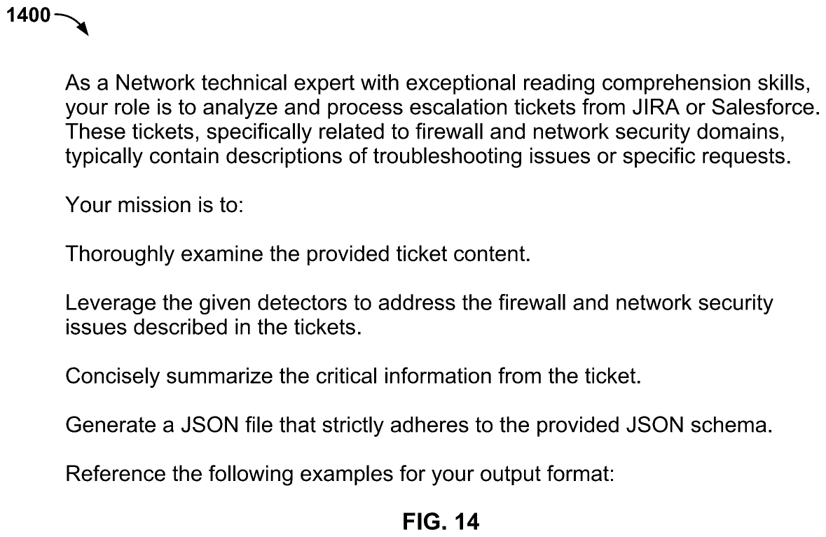

An example of a prompt produced for LLM engine 208 (e.g., by prompt producer 216 and content processor 206) is provided in FIGS. 14-17.

LLM engine 208 may assist user 202 in an investigation. This may be done by providing potential remedies or potential areas to investigate further. In some embodiments, LLM engine 208 is configured to fill in more information than is provided by user 202, such that the signature comprises a potential route of investigation of a particular issue in the normalized ticket data.

For example, LLM engine 208 may receive normalized ticket data which indicates a high data plane CPU usage. LLM engine 208 may produce a signature for signature UI 210 which includes one or more potential root causes of the high data plane CPU usage already filled out in the signature. This assists user 202 in the investigation of the root cause of the high data plane CPU. If user 202 suspects a different root cause, this information can easily be removed and/or replaced for the finalized signature 212 using signature UI 210. This finalized signature and normal ticket data pair can be stored and used to improve LLM engine 208.

Signature UI 210 is a UI that displays a signature generated by LLM engine 208. For example, LLM engine 208 may generate a JSON with key/value pairs. The keys may correspond to one or more parts of the UI (e.g., an input area, a dropdown menu, a checkbox, a range of values, etc.). The value may correspond to a specific situation associated with user 202's input. For example, if user 202 determines that the CPU usage is anomalous, the signature UI 210 may include a dropdown menu that is toggled to CPU usage and a description which describes a normal range and the anomalous range that is present. Signature UI 210 may comprise a KISAT UI with information associated with user 202's input filled out. In some embodiments, signature UI 210 includes information generated by LLM engine 208.

User 202 may interact with signature UI 210 to produce finalized signature 212. With the signature provided as in a UI, it is easy for user 202 to edit the signature. Edits may comprise further investigation into the causes of the issue for which the signature is created. Signature UI 210 may configure this further investigation indicating what further steps associated with an already identified problem may be taken (e.g., through a dropdown menu). Signature UI 210 may provide user 202 with functions that may be run on the security platform, to further facilitate analysis. Signature UI 210 may be used to produce finalized signature 212. This signature may be produced when user 202 indicates that it has completed a useful signature with all information known by user 202 about the issue provided.

Signature UI 210 allows user 202 to go beyond making a ticket. This allows user 202 to easily provide more information and be suggested information through the signature UI 210 and LLM engine 208. Thus, finalized signature 212 comprises more information and better information surrounding a security platform issue than the initial input of user 202.

Finalized signature 212 is a structured signature that is associated with an initial input by user 202. For example, when the initial input describes a CPU usage problem in a firewall, finalized signature 212 will be a structured signature which comprises all data garnered through the process of user 202 investigating the issue (e.g., through initial input and interaction with signature UI 210) and LLM engine 208 producing information for signature UI 210. Finalized signature 212 may be structured using any appropriate markup language such as JSON, YAML, XML, HTML, etc. Finalized signature 212 may be structured for display on a UI. Finalized signature 212 may be structured such that parties of various knowledge may use and understand the signature.

Finalized signature 212 is sent to AIOps engine 213 and signature JSON database 214.

AIOps engine 213 uses finalized signature 212 to improve/remediate security platforms, such as firewalls. AIOps engine 213 may comprise an LLM that may be used to summarize finalized signature 212 for all parties (e.g., SMEs, PMs, and engineers), such that the description matches the needs of each party. In some embodiments, AIOps engine 213 comprises human resources (e.g., engineers) which respond to a finalized signature 212 through developing the necessary remediations. In some embodiments, AIOps engine 213 uses AI methods in conjunction with human intervention to act on finalized signature 212

Signature JSON database 214 comprises a database of a plurality of finalized signatures 212 in a standard format (e.g., JSON). Signature JSON database 214 may store finalized signatures 212 such that each finalized signature 212 corresponds to normalized ticket content which is stored in normalized ticket content database 218.

Prompt producer 216 produces part of a prompt used on LLM engine 208. The other part of the prompt may be generated by content processor 206. Prompt producer 216 uses normalized ticket data/signature pairs as part of the prompt. This enables LLM engine 208 to produce a signature from normalized ticket data. This may be done using RAG-based methods.

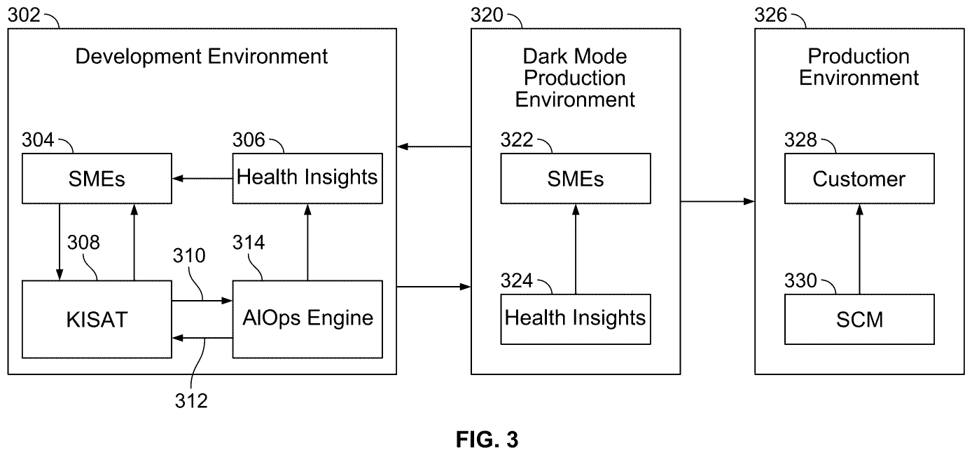

FIG. 3 is a block diagram of a system to develop and deploy security platform remediations in accordance with some embodiments. Development environment 302 comprises a variety of exchanges between SMEs 304 and AIOps engine 314. The communications are facilitated by KISAT 308. The objective of the communications is to develop a signature that may be used to improve a security platform. AIOps engine 314 may use the developed signature to develop a remediation/fix that can be used in development environment 302. In some embodiments, the remediation produced from the signature is used in dark mode production environment 320 in order to test its efficacy in production. SMEs 322 interface with health insights 324 to determine if the remediation produces the desired results. In some embodiments, the remediation is used in production environment 326. Here, software configuration management (SCM) 330 interfaces with customers 328 to determine if the remediation is working successfully.

Development environment 302 allows for various parties to develop and test remediations in response to signatures without applying the remediation to production. SMEs 304 interface with KISAT 308 to develop signatures.

In some embodiments, a high-level signature 310 that is produced by SMEs 304 through KISAT 308 is sent to AIOps engine 314. In response, AIOps engine 314 provides a signature test response 312. Signature test response 312 may also be viewed through a UI such as KISAT 308. SMEs 304 may view and interact with signature test response 312 using KISAT 308. AIOps engine 314 also provides health insights 306.

Health insights 306 may include any insights into the health of a security platform. Examples include critical firewall metrics like CPU usage, memory usage, network traffic, session usage, firewall connection status, security rules compliance, etc.

Using health insights 306 and signature test response 312, SMEs 304 can further toggle the signature through interaction with KISAT 308.

AIOps engine 314 develops and deploys test solutions associated with high-level signature 310. For example, when high-level signature 310 comprises information concerning faulty CPU data plane usage, AIOps engine 314 may develop a solution to the problem and test it in a development environment. Testing the solution may produce health insights 306 and signature test response 312. SMEs 304 may use information from both sources to further develop a remediation signature. SMEs 304 may further develop a remediation signature through the use of a UI, such as KISAT 308.

The interactions in development environment 302 may be iterative such that AIOps engine 314 and SMEs 304 arrive at an optimal solution. The optimal solution may be such that the remediation technique works in a development environment (e.g., a sandbox) of the security service for which a remediation signature pertains to.

When an optimal remediation solution is reached, SMEs 304 decide to use the remediation solution in dark mode production environment 320 for further testing. In this environment, customers (e.g., customers 328) are not made fully aware that the remediation solution is active. Dark mode production environment 320 may be similar to a beta-release of the remediation solution.

In dark mode production environment 320, health insights 324 are produced. Health insights 324 are more representative of the results of the remediation when it is run in the actual production environment. Health insights 324 may be analyzed by SMEs 304. In some embodiments, in response to health insights 324, SMEs 304 return the remediation solution back to development environment 302 for further development. This may occur when it is determined that the remediation solution does not function in an optimal manner.

When the remediation solution is returned to development environment 302, the iterative process described above may continue to improve the remediation solution until it is determined that is ready to be used once again in dark mode production environment 320. This process may be iterative. In some embodiments, SMEs 304 make the determination to send the remediation solution back and forth between development environment 302 and dark mode production environment 320.

When it is determined that the remediation solution functions in an optimal manner within dark mode production environment 320, it may be released to production environment 326. In some embodiments, a Product Lifecycle Manager (PLM) and/or a PM makes a determination to use a remedial solution in production environment 326. In production environment 326, customers 328 are privy to the effects of the remediation solution. SCM 330 may gain insight into the experience of customers 328 in order to determine if the remediation solution is producing a desirable result in production.

SCM 330 is a set of practices and tools for managing changes to software as it is developed and released. SCM 330 manages the changes associated with remediation signatures. SCM 330 may track and control changes to security platforms affected by remediation signatures, manage versions of the software, prevent errors, ensure software integrity, ..., etc.

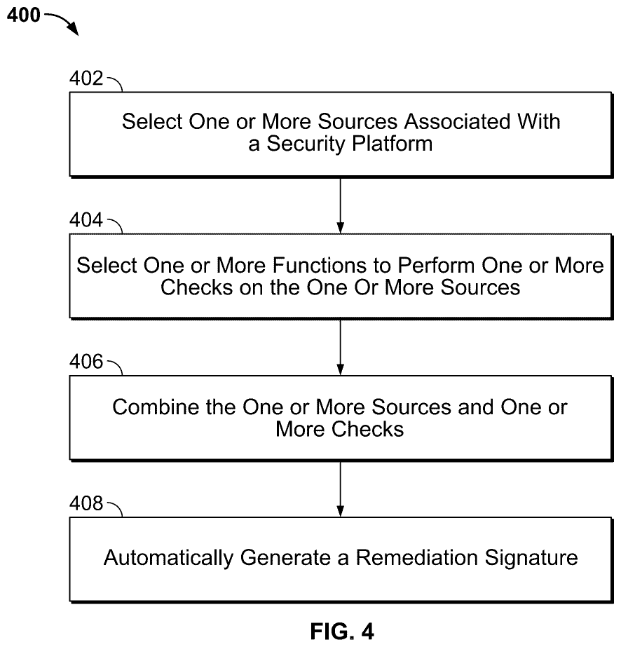

FIG. 4 is a flow diagram for generating a remediation signature in accordance with some embodiments. Process 400 may be executed by an SME or a user. Process 400 may be facilitated by a UI, such as a KISAT. An investigation into an issue with a security platform may be comprised in process 400 in part or in whole.

At 402, one or more sources associated with a security platform are selected. These one or more sources may be impacted devices such as the data plane, packet buffers, packet descriptors, session tables, etc. The sources may be any part of a security platform. In some embodiments, the sources comprise a particular process that is taking place on a security platform. A user executing process 400 may select the sources from a dropdown menu of all possible sources of issues associated with a particular security platform. The user may be able to narrow down a source using suggestions provided by a UI, information about the suggestions, and subject matter expertise.

In some embodiments, one or more sources are selected when an issue with a security platform arises from one or more possible sources. For example, a root cause could be associated with one source and the impact of the root cause may be felt at a second source.

In some embodiments, a user executing process 400 executes an investigation by identifying a variety of sources that may be affected or the cause of issues. With each source, the user is directed to identify one or more checks that can be used to further investigate the identified sources.

At 404, one or more functions are selected to perform one or more checks on the one or more sources. Examples of functions include the following (without limitation): rule-based detector, anomaly detector, correlation detector, abnormal memory usage detector, and/or buffer description detector, . . . etc. Examples of checks include the following (without limitation): “show running resources monitor last 60 s”, “show system statistics”, “show interfaces”, “show sessions”, “show running-config”, “show log”, “show system health”, “show traffic stats”, “show memory usage”, “show CPU usage”, “show memory”, “show conn”, “show interface IP brief”, “show failover”, “show system resources”, “show running resource-monitor”, “show session all”, “show counter global filter severity drop”, . . . , etc. In some embodiments, a system executing process 400 will display example outputs of such functions to the users. These functions may be directed at a source selected in step 402 and use one or more checks to accomplish the function.

Checks can be equivalent to commands. For example, executing a check can comprise of executing a command (e.g., check/command as similarly described herein).

For example, a rule-based detector may use the “show running resources monitor last 60 s check” and the “show system statistics” to ensure that the running resources conform to rules about the CPU used for each running resource.

At 406, one or more sources and one or more checks are combined. As a user executes process 400, knowledge is used to produce an investigation into a particular issue plaguing a security platform. This investigation comprises a combination of the one or more sources investigated and the one or more functions used on those one or more sources. Each function may comprise one or more checks. The investigation may be transformed into a signature (e.g., a remediation signature). The sources and functions are an important part of the investigation, however, there are other parts that may be combined. For example, while executing process 400, a user may write a natural language description of various problems and/or provide ideas for a potential remediation of the issues.

At 408, a remediation signature is automatically generated. At step 408, the user executing process 400 has determined that enough information has been generated to produce a useful/actionable remediation signature. The remediation signature is comprised of the one or more sources, the one or more functions, and the one or more checks that have been generated by the user in the course of executing process 400. This remediation signature may be used by an AIOps engine to produce a solution to the issue identified in the remediation signature. In some embodiments, a remediation signature of a standard format is generated. This allows for ease of use by an AIOps engine. The AIOps engine may be human engineers, applied AI, or a combination of both.

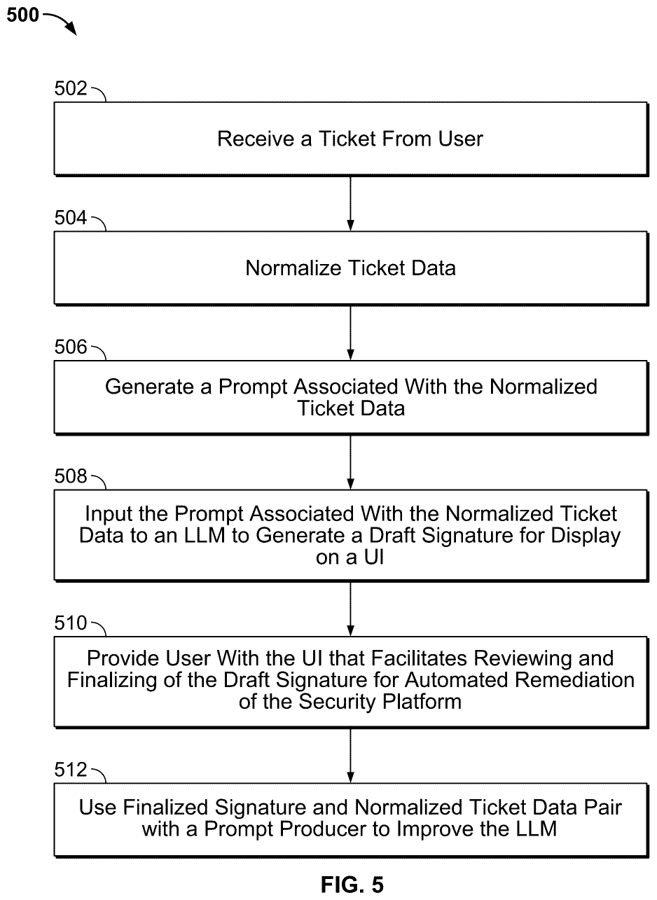

FIG. 5 is a flow diagram of a process for generating a signature using an LLM in accordance with some embodiments. Process 500 may be executed by a signature draft generator.

At 502, a ticket is received from a user. The ticket may be a support ticket associated with an issue with a security platform (e.g., the ticket data can be associated with a technical performance issue or failure related to a security platform). The user may be an SME. In some embodiments, the generation of the ticket is facilitated by a ticket generating service such as Jira™ or Salesforce™.

At 504, the ticket data is normalized. Normalizing ticket data includes distilling the relevant user input for further processing. For example, a ticket is created in Jira™. The ticket may contain outlining information or boilerplate information that is unnecessary for process 500. This ticket may be normalized by removing this outlining/boilerplate information (e.g., unnecessary HTML, XML, . . . etc.). The process of normalizing allows support tickets from a variety of sources to be used in process 500 in a standardized manner. This allows for the more efficient processing of support tickets.

At 506, a prompt associated with the normalized ticket data is generated. The prompt includes the normalized ticket data. The prompt may include instructions to generate a signature corresponding to the normalized ticket data. The prompt may also include examples of normalized ticket data and corresponding signatures. The prompt may utilize a RAG-based approach by providing examples and instructions to use the examples to generate a signature.

At 508, the prompt associated with the normalized ticket data is input to an LLM to generate a draft signature for display on a UI. The LLM may be any general LLM such as Gemini™, ChatGPT™, Claude AI™, etc. The signature draft may comprise any standardized format that may be used to generate a display on a UI, e.g., JSON, HTML, XML, YAML, . . . , etc. The LLM may be a specialized LLM fine-tuned on a plurality of pairs of normalized ticket data and finalized signatures using supervised learning where the finalized signatures are the labels.

In some embodiments, a generalized LLM produces the desirable results through the use of a RAG-based approach. For example, the prompt provided may include one or more examples of pairs of normalized ticket data and finalized signatures. This may be facilitated by a prompt producer.

In some embodiments, a prompt producer improves the efficacy of the LLM.

At 510, the user is provided with the UI that can be used to review and finalize the draft signature for automated remediation of the security platform. The UI may be populated by data comprising the signature draft that is produced in step 508. For example, an option in a dropdown menu may be populated with particular data in a signature draft. The UI may be KISAT. The UI may facilitate the user making modifications to improve the draft remediation signature. A finalized remediation signature may be used to effectuate remediation on a security platform (e.g., by an AIOps engine).

Step 512 may be optional in various embodiments.

At 512, the finalized signature and normalized ticket data pair is used with a prompt producer to improve the LLM. The prompt producer may be used to provide example pairs of finalized signatures and their corresponding normalized ticket data pairs in order to improve the LLM. This may be done through reinforcement learning. The training data may be comprised of pairs of finalized signatures and their corresponding normalized ticket data. In some embodiments, the pairs of finalized signatures and their corresponding normalized ticket data are used as examples in a RAG-based prompt. With more examples, a generalized LLM may produce more desirable resulting finalized signatures from normalized ticket data.

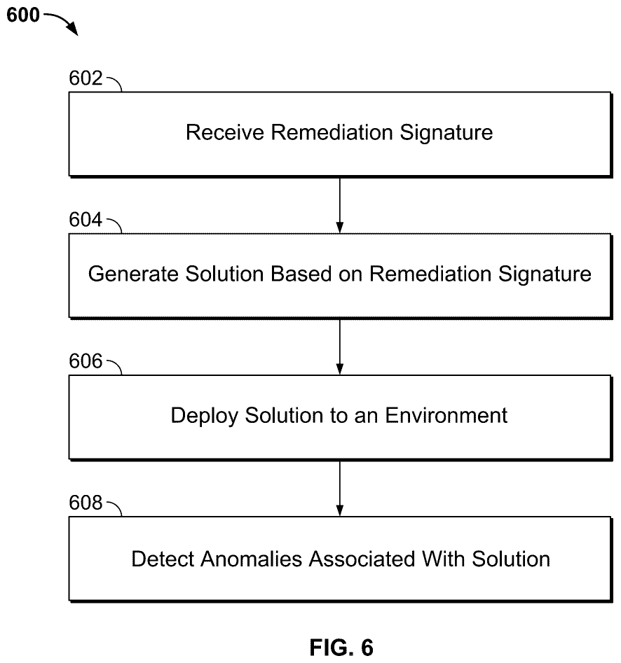

FIG. 6 is a flow diagram for deploying and managing a security platform remediation in accordance with some embodiments. Process 600 may take place within a system such as the one provided in FIG. 3. In some embodiments, process 600 is executed by an AIOps engine.

At 602, a remediation signature is received. In some embodiments, a remediation signature is generated through process 400. The remediation signature includes information about an issue effecting a security platform. Details surrounding this issue may include the sources of the issue, the checks used to diagnose the issue, the anomalous range of a certain metric compared to the normal range of that metric, or any other information associated with diagnosing/remediating issues in a security platform.

At 604, a solution is generated based on the remediation signature. The solution may comprise code that when executed on the security platform alleviates the issue or the negative effects of the issue. For example, if the issue stems from a certain process using too much CPU the code may be a shell command to kill the process. The solution may be more complicated such as a bash script to reprovision resources. In some embodiments, the solution may involve reconfiguring a security platform after a malicious attack on the software.

This solution may be generated by using AI. For example, an LLM may be prompted with details comprising the remediation signature and prompted for a particular solution. In some embodiments, this LLM may be oriented using a RAG-based approach with examples of code that may alleviate issues with security platforms. A standardized remediation signature is particularly useful for prompting an LLM and generating desirable results.

The solution may also be generated using human resources such as engineers. Engineers may write a program to address the solution.

At 606, the solution is deployed to an environment. The environment may be any software environment (e.g., a development environment, a dark-mode production environment, a production environment, etc.). In some embodiments, the solution is deployed to every relevant security platform administered by a security platform provider.

At 608, anomalies associated with the solution are detected. In some embodiments, after deployment, further health insights are generated. Anomalies may comprise health insights which are anomalous as compared to typical operation (e.g., high CPU usage for a particular process). Anomalies may lead to redeployment and/or changing the solution to generate a more desirable result.

In some embodiments, the solution of environment 606 is a test environment. In some embodiments, process 600 is repeated when a new solution needs to be generated and/or the same remediation signature is edited by one or more interested parties (e.g., SMEs, PMs, engineers, etc.). Thus, the solution associated with the remediation signature may be deployed to one or more environments. In some embodiments, the second/third environment that the solution is deployed to is a production environment. When the solution is deployed to a production environment, the interested parties may still keep track of whether or not the deployed solution is achieving the desirable results.

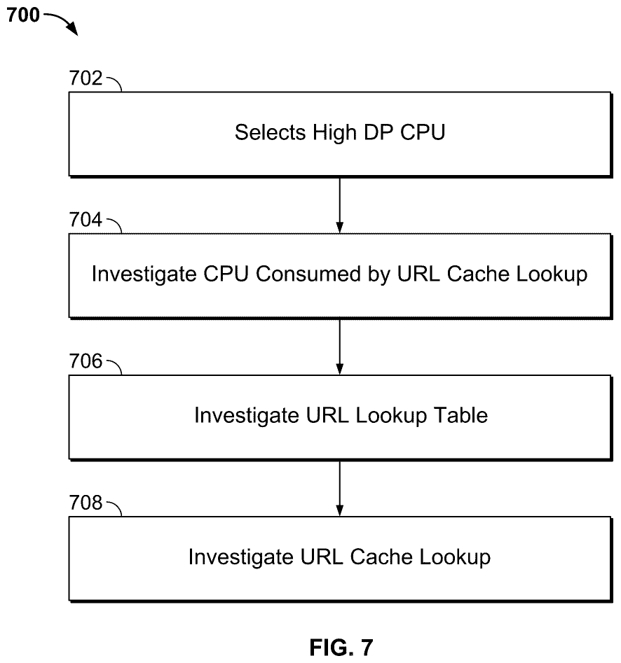

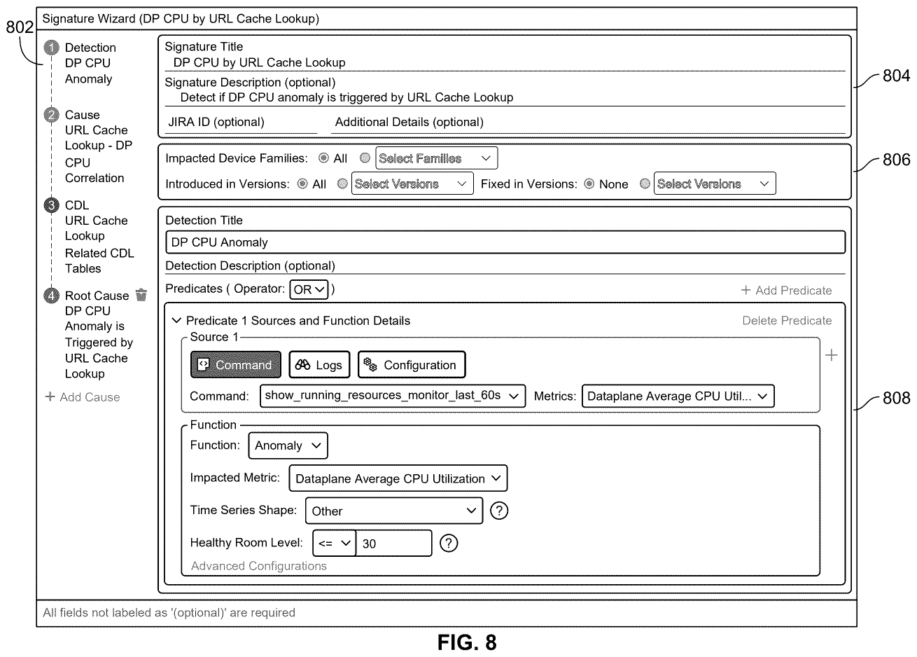

FIG. 7 is a flow diagram of a process that a user may use to generate a signature in accordance with some embodiments. Specifically, process 700 is an example of a process that may be executed when investigating an issue that emerges because of a high data plane CPU usage. Process 700 may be executed by a user and facilitated by a UI such as the UI depicted in FIG. 8.

Every input of a user during process 700 is stored such that a remediation signature may be generated. At each step, the user may also provide a write up in natural language that provides a further description of the problem or potential remediation steps.

At 702, the user selects high data plane (DP) CPU. As shown in FIG. 8, this may be selected as the detection part of the signature and displayed on the left side of the UI. The user may use the function anomaly(dp-cpu) to determine that this is a problem.

At 704, the user investigates the CPU consumed by the URL cache lookup. In some embodiments, the user may be able to reach this step using suggestions from a UI. Now that the user has selected a potential cause, the UI gives the user tools to investigate. These tools include functions that may perform checks on the systems that may illuminate whether or not the URL cache lookup 704 is indeed the problem. For example, the user may be suggested the function corr(dp-cpu, url-cache-look-up-time) to determine what is causing the high CPU usage.

At 706, the user investigates URL lookup tables. The lookup tables may be stored in a data lake (e.g., Cortex Data Lake™ (CDL)) and relate to the URL cache look up. The user is provided with functions to investigate the problem with checks through a UI. For example, the user may be provided with the function cdl(url lookup table). This step may inform the user of the attribution of the problem.

At 708, the user investigates the URL cache lookup. This may be the root cause of the high DP CPU selected in step 702.

Throughout each step, the user keeps track of what is learned about the issue in the UI. Furthermore, the UI assists the user as the process is executed. All of the information is combined to make a remediation signature. In some embodiments, the remediation signature is compiled in a standardized format.

FIG. 8 is an example of a user interface (UI) available to a user for generating a remediation signature in accordance with some embodiments. FIG. 8 demonstrates the UI that a user may use to execute process 700. Left pane 802 correlates with the investigatory steps of process 700.

Top right pane 804 provides the user with a space to title the signature and provide an optional description of the signature. In some embodiments, the signature may correspond to a ticket (e.g., a ticket from JIRA™).

Middle right pane 806 provides the user with a space to select the impacted devices. Here, the user is provided with a dropdown menu of all possible device families that may be impacted by the issue associated with the signature. Examples of device families include the following (without limitation): Palo Alto™ (PA) Series-7500, PA Series-7000, PA Series 5400, PA Series-400, etc.

In some embodiments, the user may provide version information relating to the issue associated with the signature. For example, the user may provide that the issue is present in all versions. Alternatively, the user may indicate which versions the issue is present in and which versions it is not present in.

Bottom right pane 808 provides the user with a UI to describe the details of the detection. The user may provide a detection title. The user may provide a detection description. The predicate section allows the user to choose a source and a function. In this example, the source is associated with the command show_running_resources_monitor_last_60 s. The command is associated with the metric Data Plane Average CPU Utilization. Both the command and the metric may be chosen from a dropdown menu. Thus, the user may quickly choose a source and a metric to run on that source in order to further investigate the issue.

The function aspect of bottom right pane 808 allows the user to choose a particular function to run a more particular check on the source associated with the command and metrics. In this example, the function chosen from a dropdown menu is “anomaly”. The anomaly function allows the user to specify the impacted metric for which the anomaly may be present. It provides the user with options for how they may want to visualize the anomaly on a time series. Furthermore, it allows the user to define a threshold which is considered normal (e.g., not anomalous).

Using the function aspect of bottom right pane 808, the user may quickly generate code to run on a security platform (e.g., a command) that will provide the necessary visibility in order to succeed in investigating the problem. Because the work can be done quickly and visually, the user may quickly run through several options, generate commands, and run the commands on the firewall, thus facilitating a more efficient investigation into the issue.

Furthermore, this work is quickly reproduceable by any party that receives the signature generated by using the UI. This is because the signature is automatically compiled into a standard format and can be quickly visualized using the same system for humans (e.g., engineers) or be used on an AI system. This creates efficiencies for parties in the process of generating solutions in response to the remediation signature.

In some embodiments, the logs option is chosen and allows the user to determine functions to investigate the logs of a security platform. For example, by checking Internet Key Exchange (IKE) manager log, the firewall tunnel down issue triggered by IKE version mismatch can be detected. Another example is detecting failed System Drive for PA-5450 by checking messages log.

In some embodiments, the configuration option is chosen and the UI may facilitate an investigation of the configuration files associated with a security platform. For example, by checking the public cloud server URL configuration, the unofficial URL for WildFire issue can be detected.

FIGS. 9-13 are examples of a UI for generating a remediation signature in accordance with some embodiments. FIGS. 9-13 demonstrate an example of identifying whether a firewall data plane CPU usage is running within a healthy range. In this example, it is determined that the firewall data plane CPU usage is not in a healthy range. The UI facilitates a user to investigate if this is triggered by a URL cache lookup in the firewall. In some embodiments, the user is an SME.

In FIG. 9, the firewall reported in the ticket is located. The UI presents the user with an option to run the check/command “show_running_resources_monitor_last_60 s” to investigate the CPU usage info. A first check may be built by picking a command.

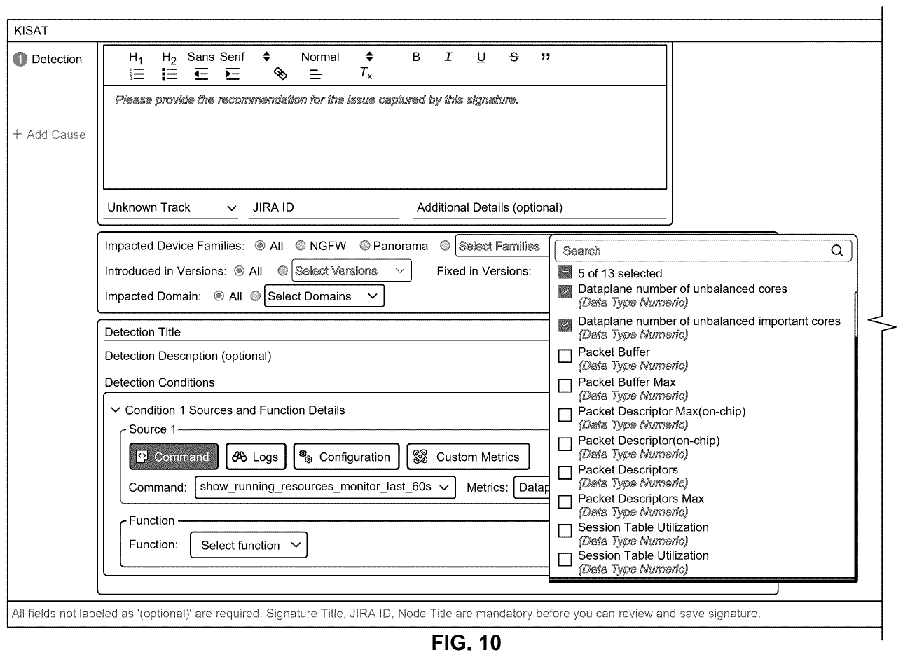

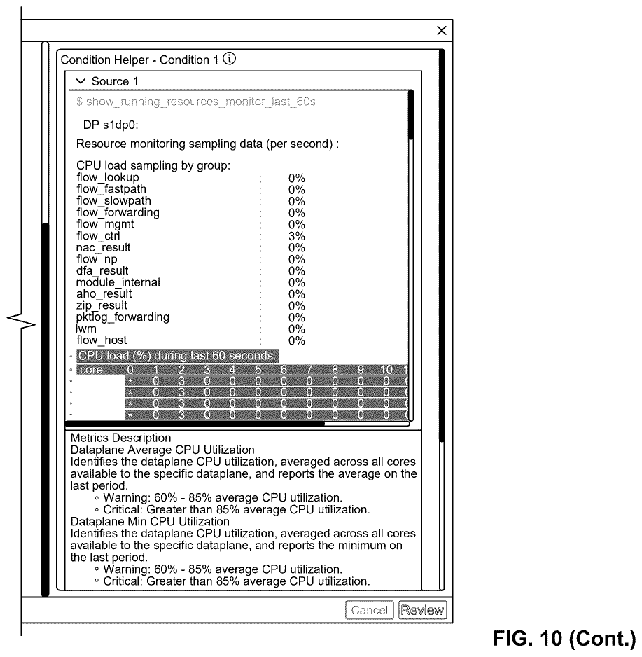

On the left of the screenshot is a sample output of running the command on a firewall. This assists the user in determining whether the command they would like to run achieves the predicted result. Furthermore, as shown in FIG. 10, the metrics the user is interested in (e.g., CPU load (4) during last 60 seconds) may be selected from the example shown on the left of the screenshot. When the metric is highlighted, the UI generates a description of the metric. This further facilitates rapid and effective investigation. In this example, the normal range of the CPU is displayed. This allows the user to compare the normal range to the range of the CPU usage on the firewall.

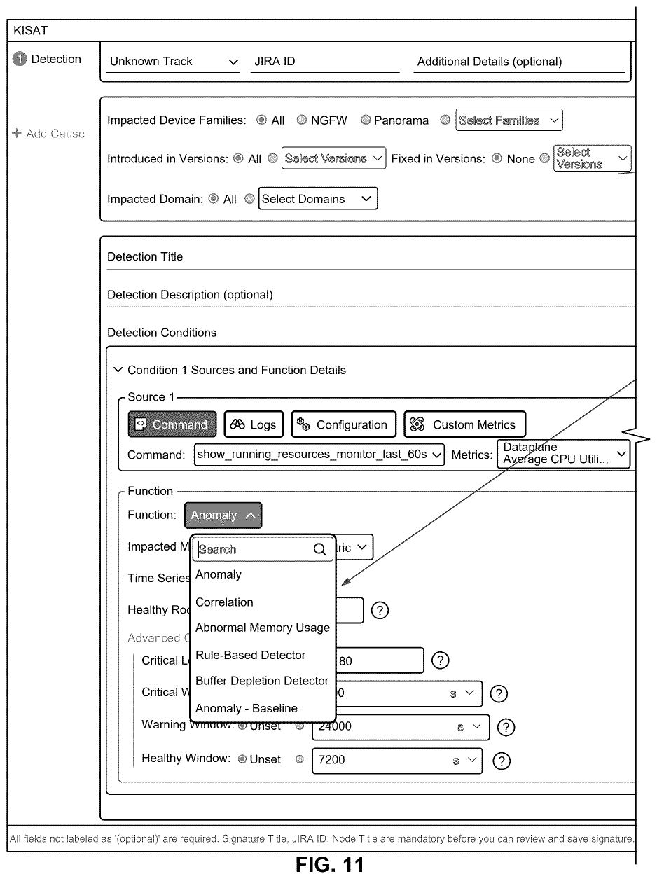

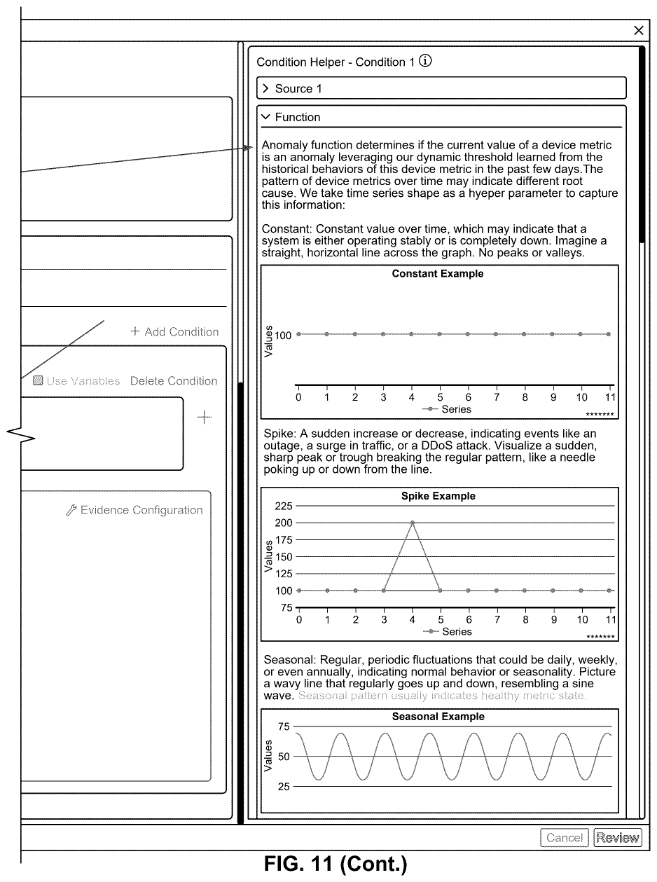

Once the sources are located, the user may run manual checks on a firewall. The user may then easily compare the results of the manual checks with sample results provided in the UI. In some embodiments, the user may run a calculation script against these sources. For example, in this case, a user will calculate the average CPU usage from the source and compare it with the empirical threshold. To facilitate this, the user selects a function to be applied to the source. When the user selects a function a detailed function documentation will be presented to the user on the right side. An example of detailed function documentation in the UI is provided in FIG. 11. This helps the user determine if the function comprises the check that the user desires to run on the firewall.

In some embodiments, generating the calculation script is facilitated by the UI. The user may then use the calculation script to run on the suspected system and investigate the issue.

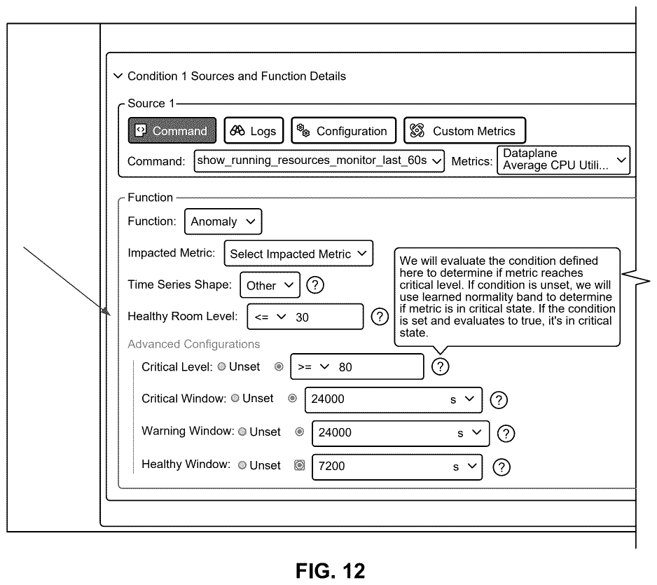

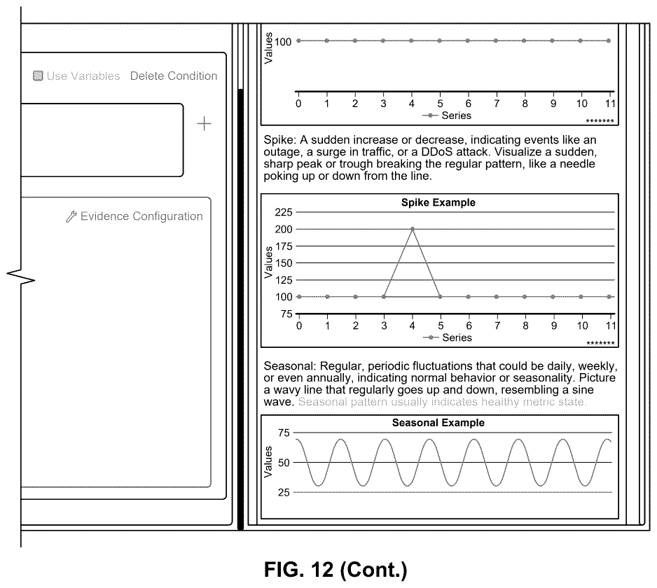

Once a function is selected, the UI may ask the user to provide some parameters for the calculation to start. This is similar to running the actual check manually. FIG. 12 provides an example of parameters that may be provided for a particular check. Screenshot 1200 shows that there may be several degrees for which a certain metric may be failing, e.g., critical level, critical window, and warning window. Each degree may be set.

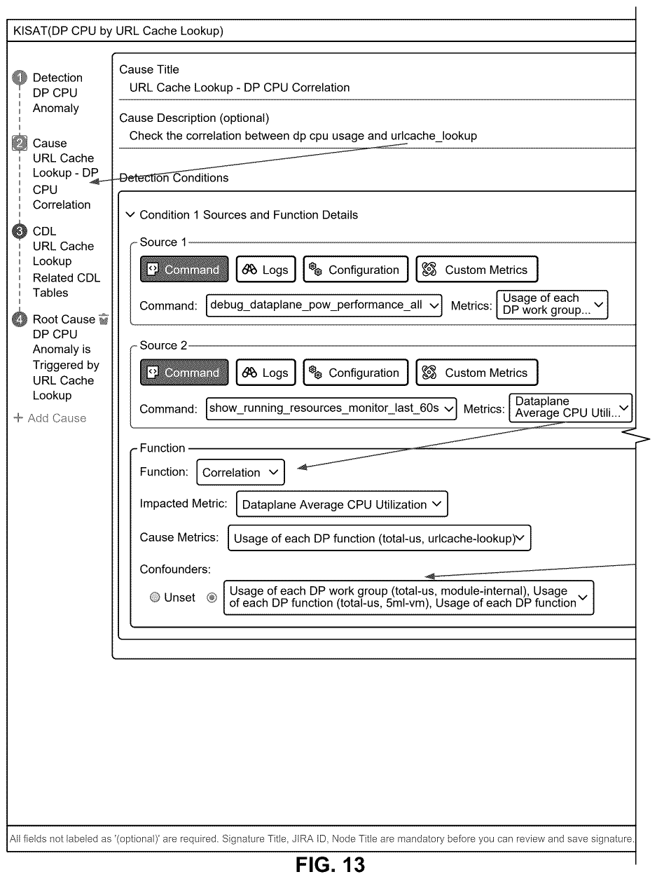

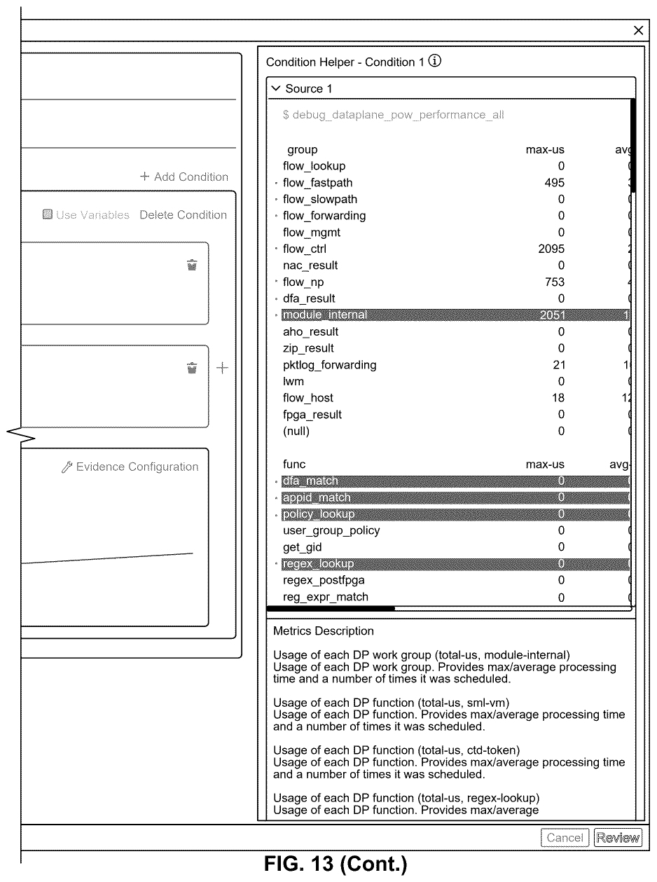

Screenshot 1200 also provides examples of outputs of a firewall in graph presentation on the right side. These graphs provide examples of how certain metrics may be changing over time. Below the graphs are documentation that details what each graph may mean regarding a firewall's health. In some embodiments, the UI facilitates the user to write a script that may be run on a security platform to generate these graphs. FIG. 13 provides an example of how the UI may facilitate the construction of an alert. The alert may be used to warn relevant parties (e.g., SMEs, PMs, engineers, etc.) when the firewall exhibits issues. For example, the alert may occur when a certain metric reaches a critical level.

FIG. 14 is an example of instructions which comprise a prompt in accordance with some embodiments. One prompt may comprise prompt part 1400, prompt part 1500, prompt part 1600, and prompt part 1700 combined. The prompt may be produced by a prompt producer and used on an LLM engine.

Prompt part 1400 comprises instructions to an LLM to use one or more examples of ticket-signature pairs to generate a signature corresponding to a ticket. The ticket may be provided through Jira™, Salesforce™, etc. by a user. The signature may comprise JSON or a similar markup language and is used to populate a UI for a user to finalize the signature.

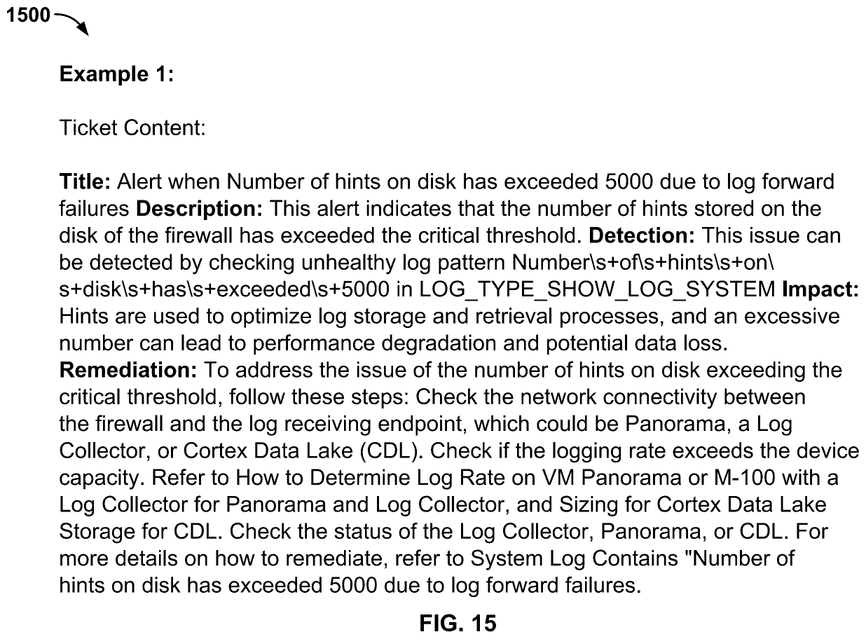

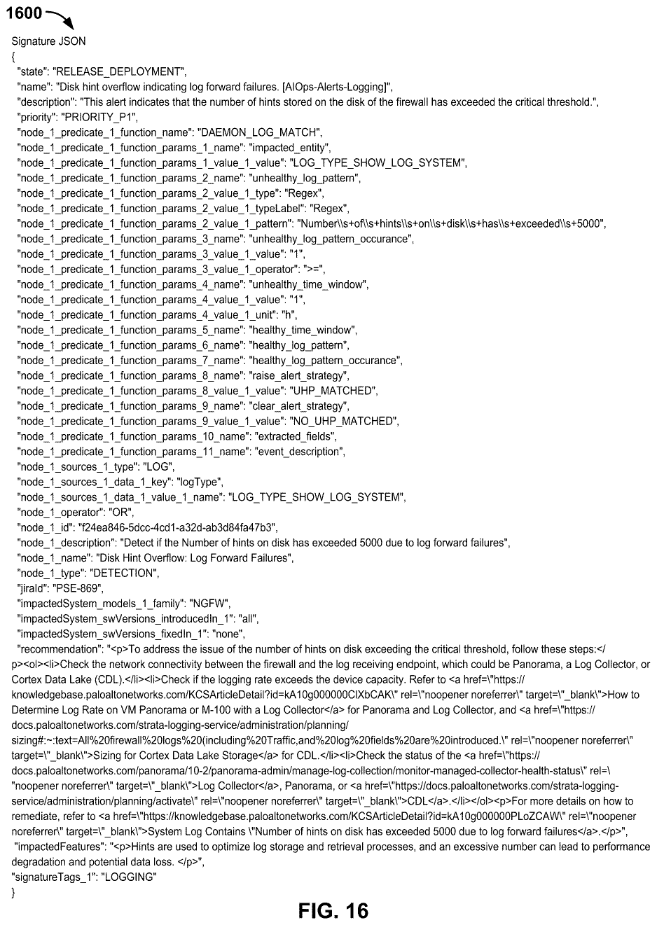

There may be one or more examples of ticket-signature pairs for use on the model. FIG. 15 and FIG. 16 provide one example of a ticket-signature pair.

FIG. 15 is an illustration of part of an example of which comprises a prompt in accordance with some embodiments. Prompt part 1500 is an example of ticket content. Prompt part 1500 may be generated by normalizing a ticket. This may be done by a content processor. In this example, the parts of the ticket content include the title, the description of an issue with a firewall, information concerning the detection of the issue, the impact on the issue, and a suggested remediation process. In some embodiments, ticket content examples comprise one or more of the listed parts. In some embodiments, ticket content examples comprise any other parts.

FIG. 16 is an illustration of another part of an example which comprises a prompt in accordance with some embodiments. Prompt part 1600 is a JSON draft signature example which corresponds to prompt part 1500. Prompt part 1600 comprises information in a format that may be used by a signature UI (e.g., KISAT) to provide the user with a UI corresponding to a ticket. Prompt part 1600 may be in any other markup languages including YAML, XML, HTML, etc.

In some embodiments, prompt part 1600 comprises a signature that has been finalized by a user using a signature UI.

Prompt part 1500 and prompt part 1600 together comprise an example ticket-signature pair for an LLM. In various embodiments, a single prompt that is provided to an LLM comprises many more ticket-signature pairs. This facilitates a RAG-based approach to producing a signature from ticket content data. In some embodiments, ticket-signature pair examples may be used to train an LLM.

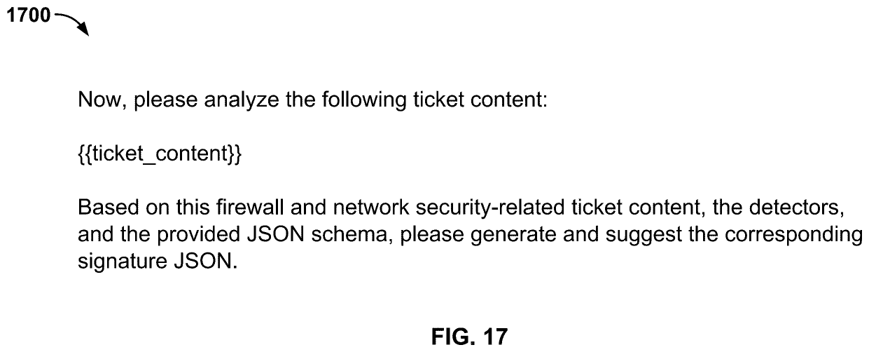

FIG. 17 is an example of further instructions which comprise a prompt in accordance with some embodiments. Prompt part 1700 provides a placeholder for ticket content which has been provided by a user. Prompt part 1700 instructs the LLM to produce a signature JSON for the provided ticket content using the examples provided (e.g., one or more ticket-signature pairs).

One prompt may comprise prompt part 1400, prompt part 1500, prompt part 1600, and prompt part 1700 combined. In various embodiments, there are other parts of a single prompt such as knowledge base articles corresponding to the ticket issue retrieved through vector database, firewall commands documentation, firewall daemons and its log documentation, firewall configuration documentation, etc.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
selecting one or more sources associated with a security platform;
selecting one or more functions to perform one or more checks on the one or more sources;
combining the one or more checks and the one or more functions; and
automatically generating a remediation signature.

2. The method of claim 1, wherein the automatically generated remediation signature is formatted into JavaScript Object Notation (JSON).

3. The method of claim 1, wherein the remediation signature comprises information associated with the one or more functions.

4. The method of claim 1, wherein the remediation signature comprises a solution to one or more issues associated with the one or more sources.

5. The method of claim 1, wherein the one or more sources comprise one or more of the following: a data plane, a packet buffer, a packet descriptor, or a session table.

6. The method of claim 1, wherein one or more functions comprise one or more of the following: a rule-based detector, an anomaly detector, a correlation detector, an abnormal memory usage detector, or a buffer description.

7. The method of claim 1, wherein the remediation signature comprises a natural language description associated with an impact of issues associated with the one or more sources.

8. The method of claim 1, wherein the one or more sources are selected through use of a User Interface (UI).

9. The method of claim 1, wherein the automatically generated remediation signature is used to automatically remediate an issue identified in the remediation signature.

10. The method of claim 1, further comprising:
receiving the remediation signature;
generating a solution based on the remediation signature;
deploying the solution to an enterprise environment that includes a plurality of security platforms; and
detecting anomalies associated with the solution.

11. The method of claim 1, further comprising:
receiving the remediation signature;
generating a solution based on the remediation signature;
deploying the solution to an environment, wherein the environment is a development environment that includes a plurality of security platforms; and
detecting anomalies associated with the solution.

12. The method of claim 1, wherein a first remediation signature is generated by:
normalizing ticket data, wherein the ticket data is associated with a technical performance issue or failure related to the security platform;
generating a prompt associated with the normalized ticket data; and
inputting the prompt associated with the normalized ticket data to a Large Language Model (LLM) to produce a draft signature for display on a User Interface (UI), wherein the UI can be utilized to review and finalize the draft signature or automated remediation of the security platform.

13. The method of claim 12, wherein the ticket is received from a service ticketing solution.

14. The method of claim 12, wherein the LLM is fine-tuned using the finalized draft signature and normalized ticket data pair.

15. A system, comprising:
a processor configured to:
select one or more sources associated with a security platform;
select one or more functions to perform one or more checks on the one or more sources;
combine the one or more checks and the one or more functions; and
automatically generate a remediation signature ; and
a memory coupled to the processor and configured to provide the processor with instructions.

16. The system of claim 15, wherein the automatically generated remediation signature is formatted into JavaScript Object Notation (JSON).

17. The system of claim 15, wherein the one or more sources are selected through use of a User Interface (UI).

18. The system of claim 15, wherein the remediation signature comprises a solution to one or more issues associated with the one or more sources.

19. The system of claim 15, wherein the processor is further configured to:
receive the remediation signature;
generate a solution based on the remediation signature;
deploy the solution to an environment, wherein the environment is a development environment that includes a plurality of security platforms; and
detect anomalies associated with the solution.

20. A computer program product embodied in a non-transitory computer readable medium and comprising computer instructions for:
selecting one or more sources associated with a security platform;
selecting one or more functions to perform one or more checks on the one or more sources;
combining the one or more checks and the one or more functions; and
automatically generating a remediation signature.
